(19) United States
(12) Patent Application Publication
(10) Pub. No.: US 2026/0101190 A1
(43) Pub. Date: Apr. 9, 2026

(54) SYSTEMS AND METHODS FOR USING A WEB BLUETOOTH API FOR MOBILE ACCESS CONTROL

(71) Applicant: ASSA ABLOY AB, Stockholm (SE)

(72) Inventors: Sivarajan Manoharan, Chennai (IN); Jeyamurga Ganesan, Chennai (IN)

(21) Appl. No.: 19/112,756

(22) PCT Filed: Sep. 18, 2023
(86) PCT No.: PCT/EP2023/075598

§ 371 Date: Mar. 18, 2025

(30) Foreign Application Priority Data
Sep. 21, 2022 (IN) 202241054095

(51) Int. Cl. H04W 12/08; G06F 16/955; H04W 12/06; H04W 12/69

(52) U.S. Cl. CPC H04W 12/08; G06F 16/955; H04W 12/068; H04W 12/69

(57) ABSTRACT

Disclosed herein are systems and methods for using a web/Bluetooth API for mobile access control. In an embodiment, a computing system receives an endpoint identifier associated with a visitor. The system generates a URL associated with the endpoint identifier, and transmits the URL to an endpoint associated with the endpoint identifier. The system receives, from a mobile device associated with the visitor, a request for a web/Bluetooth Low Energy (BLE) webpage corresponding to the URL. The system generates the requested webpage, and transmits the webpage to the mobile device. The webpage contains a valid credential for access to a secured resource, and also contains executable code for calling at least one function of a web/BLE API. The system transmits the webpage to the mobile device, and thereafter receives the credential from the mobile device via a BLE communication, verifies the credential, and accordingly grants access to the secured resource.

### PRIORITY APPLICATION

This application claims priority to Indian Patent Application Serial No. 202241054095, filed Sep. 21, 2022, the disclosure of which is incorporated by reference herein in its entirety.

### TECHNICAL FIELD

Among other technical fields, embodiments of the present disclosure pertain to access control systems (including physical, electronic, logical, etc. access control systems), web design, wireless communication (e.g., Bluetooth), application programming interfaces (APIs), and, more particularly, to systems and methods for using a web Bluetooth API for mobile access control.

### BACKGROUND

Security is an ever-increasing concern in today's world. This concern extends to, among other areas of life, security related to protecting physical spaces such as homes, offices, labs, engineering facilities, hospitals, and so forth. In a typical arrangement, and using a particular floor of an office building as an example physical space, that floor (and/or the office building generally, particular rooms, elevator banks, and the like therein) may be protected by what is known in the art as a physical access control system (PACS) or electronic access control system (EACS), among other possibilities.

In an example situation, one or more elevators to the particular floor may open into a small lobby that includes a secure door that, when closed and locked, prevents physical access to the rest of the floor. A locking mechanism for that door may be controlled by a device known as a reader. This reader could be operable to respond to one or more types of wireless communication from one or more devices such as radio frequency (RF) tags, fobs, keycards, mobile devices (e.g., Bluetooth or Bluetooth Low Energy (BLE)), and/or the like. In some cases, a reader may also have a keypad that can be used to key in a valid credential (e.g., a correct passcode). As a general matter, upon receipt from a given device (or its own keypad in some cases) of a valid credential, the reader may unlock the door to permit access to the rest of the floor. In a typical case, the door may then automatically close and lock on its own.

A given valid credential could take a number of different forms and include one or more encrypted and/or unencrypted data values. More generally, it is noted that, in the present disclosure, the term “credential” is used broadly to encompass any set of one or more (encrypted and/or unencrypted) values that are provided for access to-or activation of, etc.-a given resource, be it a physical space as in the aforementioned example of a floor of an office building, an electronic resource (e.g., a given computing terminal, a given network server, a given online account (e.g., bank account), and/or the like), and/or one or more other protected resources.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts an example security arrangement in which at least one embodiment may be carried out.

FIG. 2 depicts an example method, in accordance with at least one embodiment.

FIG. 3 depicts an example information-flow diagram, in accordance with at least one embodiment.

FIG. 4 depicts an example user interface of an example enrollment portal, in accordance with at least one embodiment.

FIG. 5A depicts a first example mobile-device screenshot, in accordance with at least one embodiment.

FIG. 5B depicts a second example mobile-device screenshot, in accordance with at least one embodiment.

FIG. 5C depicts a third example mobile-device screenshot, in accordance with at least one embodiment.

FIG. 5D depicts a fourth example mobile-device screenshot, in accordance with at least one embodiment.

FIG. 5E depicts a fifth example mobile-device screenshot, in accordance with at least one embodiment.

FIG. 6 depicts an example computer system that could be configured to perform at least one embodiment and/or embody one or more devices, systems, and/or the like in accordance with at least one embodiment.

FIG. 7 depicts an example software architecture that could be implemented on a computer system such as the example computer system of FIG. 6, in accordance with at least one embodiment.

### DETAILED DESCRIPTION

With respect to current implementations of access control systems that utilize BLE communication between a given mobile device and a given reader, users are required to install (or have already installed) a particular app on their mobile device, and then use that app to request access to a particular secured resource. Assuming approval of such a request, the app may receive a valid credential from a given server, or may generate a valid credential upon entry by the user of a given invitation code or the like into the user interface of the app. However the app obtains the valid credential, it may then utilize the Bluetooth interface of the mobile device to conduct BLE communications to connect to a given reader and then transmit the valid credential to the reader to achieve the desired access. Thus, even for short-term access to a given secured resource, users are inconvenienced (and often annoyed) by having to download and install a particular app on their mobile device. Many users are wary for security reasons and privacy reasons of installing unknown apps on their mobile devices.

To address these and other shortcomings of prior implementations, disclosed herein are embodiments of systems and methods for using a web Bluetooth API for mobile access control. In an example embodiment, an engineer at an engineering company wants to meet with an outside patent attorney at the engineer's office building. At that building, the engineer works in a section that is behind a door that is secured by a locking mechanism and a reader in a manner similar to the above-described example. In this embodiment, the engineer uses an enrollment portal (on, e.g., their company's intranet) to register and invite the prospective visitor. The engineer types (into corresponding fields) the patent attorney's first name, last name, mobile number, an expiration date for the visitor privileges, and selects the relevant reader from a dropdown list of readers at the engineer's office building.

In response to the engineer submitting this data via the enrollment portal, the portal generates a visitor-specific URL and transmits that URL (via, e.g., text message) to the patent attorney's mobile device. When the patent attorney arrives at the engineer's offices, the patent attorney taps on the URL, at which point his mobile device sends a request to that URL and receives back a corresponding webpage. In at least one embodiment, this webpage has been generated such that it includes executable code (e.g., JavaScript) that uses a web Bluetooth API to instruct the mobile device to perform certain functions. The webpage in this example also includes a valid credential for the visitor (i.e., the patent attorney) to use for accessing the reader.

The mobile device may load this webpage using its browser and then begin executing that code. In some cases, the code checks whether Bluetooth and location (i.e., location-based services) are both enabled at that time on the mobile device. If need be, the visitor may be prompted to enable one or both. The webpage may then use the web Bluetooth API to display a list of nearby Bluetooth devices, which in this example includes the reader specified by the engineer via the enrollment portal. The patent attorney may then tap to connect to (e.g., pair with) the reader, which the webpage may then responsively accomplish.

Next, the webpage may present the patent attorney with a button that the patent attorney can tap to cause the webpage to use the web Bluetooth API to submit the valid credential to the reader via BLE communication. The reader may then verify this credential (in some cases by checking with an access server, which may have been provided with matching credential data by the server that generated and sent the webpage, among other possible implementations). Upon successful verification of the credential, the reader may actuate the locking mechanism to unlock the door, granting access to the visitor.

Embodiments of the present disclosure have several advantages over prior implementations. Included in these advantages is that the visitor does not need to install any particular access application in order to be able to successfully submit a valid credential to the reader. Instead, embodiments of the present disclosure utilize a web browser that is already installed on the visitor's mobile device. One can hardly obtain a mobile device these days that does not come provisioned with at least one web browser if not more. Embodiments of the present disclosure therefore provide access control across multiple platforms and across multiple browsers. With embodiments of the present disclosure, visitors need not have the security and privacy concerns that come with installing an unfamiliar app, and because BLE connections are typically protected using AES-128 end-to-end encryption. Moreover, in accordance with embodiments of the present disclosure, visitors are not prompted to key in any particular invitation code or the like in order to gain access to the corresponding secured resource. Other advantages will be apparent to those of skill in the relevant arts having the benefit of the present disclosure.

One embodiment takes the form of a method that this performed by executing instructions on at least one hardware processor of a computing system. In accordance with the embodiment, the computing system receives an endpoint identifier associated with a visitor. The computing system generates a Uniform Resource Locator (URL) associated with the endpoint identifier, and transmits that URL to an endpoint that is associated with the endpoint identifier. The computing system receives, from a mobile device that is associated with the visitor, a request for a web/BLE webpage corresponding to the URL. The computing system generates the requested web/BLE webpage, which contains a valid credential for access to a secured resource, and which also contains executable code that includes at least one call to at least one function of a web Bluetooth API. The computing system transmits the web/BLE webpage to the mobile device of the visitor. Thereafter, the computing system receives the credential from the mobile device of the visitor via a BLE communication. The computing system then verifies the credential and accordingly grants access to the secured resource.

As described herein, one or more embodiments of the present disclosure take the form of methods that include multiple operations. One or more other embodiments take the form of systems that include at least one hardware processor and that also include one or more non-transitory computer-readable storage media containing instructions that, when executed by the at least one hardware processor, cause the at least one hardware processor to perform multiple operations (that in some embodiments do and in other embodiments do not correspond to operations performed in a herein-disclosed method embodiment). Still one or more other embodiments take the form of one or more non-transitory computer-readable storage media (CRM) containing instructions that, when executed by at least one hardware processor, cause the at least one hardware processor to perform multiple operations (that, similarly, in some embodiments do and in other embodiments do not correspond to operations performed in a herein-disclosed method embodiment and/or operations performed by a herein-disclosed system embodiment).

Furthermore, a number of variations and permutations of embodiments are described herein, and it is expressly noted that any variation or permutation that is described in this disclosure can be implemented with respect to any type of embodiment. For example, a variation or permutation that is primarily described in this disclosure in connection with a method embodiment could just as well or instead be implemented in connection with a system embodiment and/or a CRM embodiment. Furthermore, this flexibility and cross-applicability of embodiments is present in spite of any slightly different language (e.g., processes, methods, methodologies, steps, operations, functions, and/or the like) that is used to describe and/or characterize such embodiments and/or any element or elements thereof.

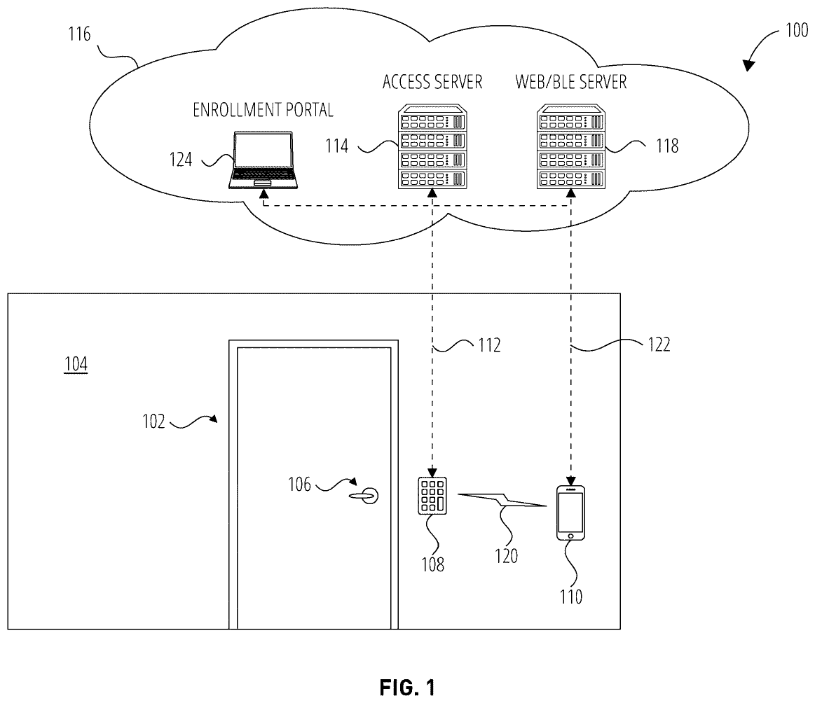

FIG. 1 shows an example security arrangement 100 that may be used in connection with at least some embodiments of the present disclosure. As a general matter, the examples that are provided in the present disclosure largely involve using a mobile station (including its web browser and Bluetooth interface) to gain access to a physical resource such as a floor of a building. It should be understood, however, that this is purely for clarity of presentation and by way of example. One or more of the various embodiments that are described herein may be applied to other contexts, in connection with access to (and/or activation of, etc.) one or more different physical and/or electronic (e.g., computing) resources, logical resources, and/or the like. As examples, one or more of the various embodiments of the present disclosure could be applied to an EACS, a logical access control system (LACS), and/or the like. Different types of wireless communication could be used with suitable APIs. Moreover, again with suitable APIs, applications other than web browsers could be used as well. Additional and/or different applications may occur to those of skill in the art having the benefit of the present disclosure.

As can be seen in FIG. 1, in the example security arrangement 100, a door 102 is disposed on a wall 104, behind which may be a protected resource. In the present example, that protected resource is most of the floor of a given building (e.g., other than an elevator lobby). The door 102 has disposed thereon a handle 106, which in this example is equipped with a locking mechanism (not explicitly depicted) that is controlled by a reader 108. In the depicted scenario, the reader 108 is positioned proximate the door 102, and in particular is positioned proximate the handle 106 of the door 102. The handle 106 may have at least a locked state and an unlocked state.

In an example scenario, the handle 106 is in the locked state in its default mode of operation, and the reader 108 is operable to selectively place the handle 106 in the unlocked state responsive to being presented with an authorized credential by, e.g., a mobile device in accordance with embodiments of the present disclosure. As noted above, the reader 108 may also work with other types of secure devices, keypad entry, and/or the like. In the example that is depicted in FIG. 1, a mobile device 110 is shown as being in wireless communication with the reader 108. In the depicted embodiment, the mobile device 110 is the mobile device of the visitor, and the depicted wireless connection 120 utilizes BLE communication.

In some arrangements, the reader 108 itself may locally determine whether or not to grant access. In other arrangements, the reader 108 may consult an access server 114 (and/or other entity, device, system, etc.) via a communication link 112 in making a decision to grant or deny access. As used in the present disclosure, unless otherwise specified, a given communication link may include one or more wired-communication links and/or one or more wireless-communication links, as deemed suitable by those of skill in the art for a given implementation and/or in a given context. The access server 114 may include one or more devices, and may be part of (and/or resident in, etc.) a cloud system 116, as an example. In some instances, an onsite controller may be queried by the reader 108 as part of determining whether to grant or deny access to a given resource. Other arrangements are possible as well.

Furthermore, it can also be seen in FIG. 1 that the cloud system 116 includes an enrollment portal 124 and a web/BLE server 118, both of which are further discussed below. In some embodiments, the mobile device 110 may communicate over a communication link 122 with the web/BLE server 118. The various dashed-line arrows in FIG. 1 are intended to indicate that the various corresponding devices could communicate with one another, not that they necessarily do. Moreover, there could be one or more communication links not explicitly depicted in FIG. 1.

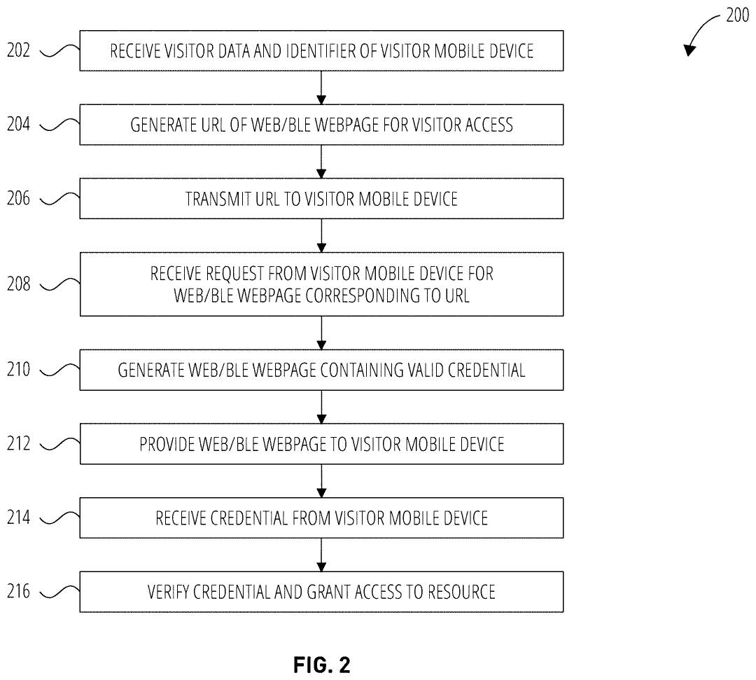

FIG. 2 depicts an example method 200 that may be carried out in accordance with at least one embodiment of the present disclosure. In this description, the method 200 is described as being carried out by a computing system that is referred to in the present disclosure as a visitor-management system (VMS). In various different embodiments, a VMS can include one or more of the reader 108, the access server 114, the web/BLE server 118, and the enrollment portal 124. A given VMS could also include one or more other devices, systems, entities, and/or the like instead of or in addition to one or more of those listed devices.

In the example described below, the referenced VMS includes the reader 108, the access server 114, the web/BLE server 118, and the enrollment portal 124. As such, various operations may be described below as being performed by one of those enumerated devices (or systems, etc.), though it should be understood that such a description is also a description of the referenced VMS as a whole carrying out the method 200. In other embodiments, the method 200 could be performed by any one or more computing devices, systems, and/or the like that are suitably equipped and programmed to perform the herein-described operations.

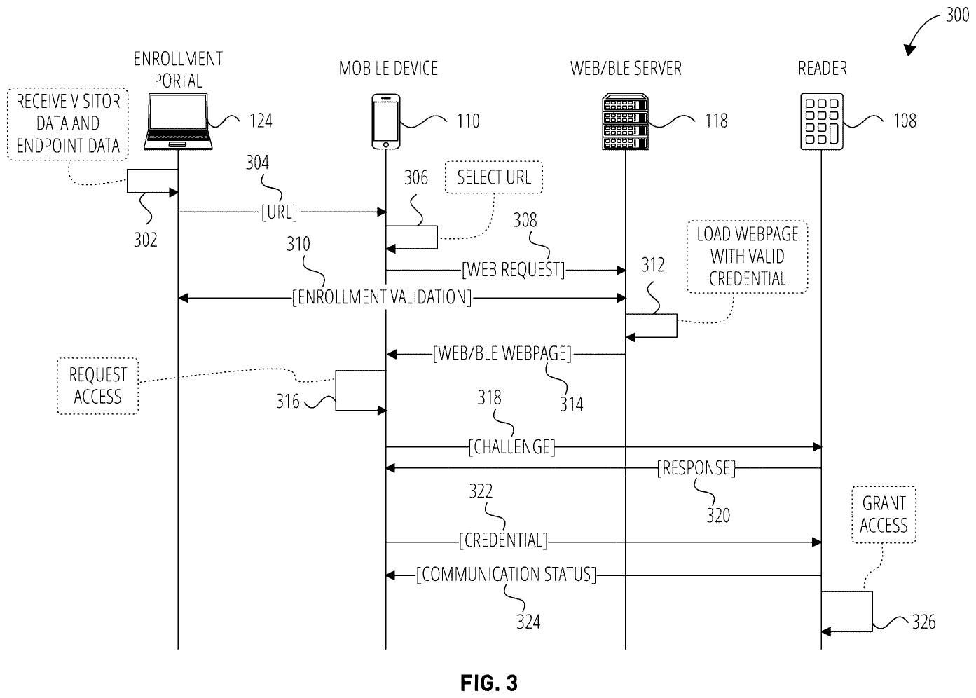

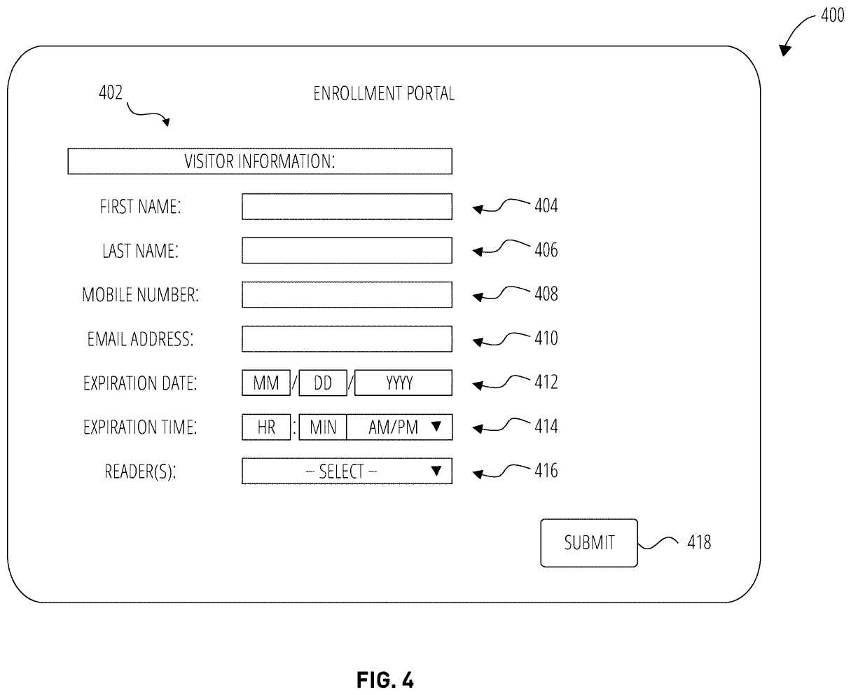

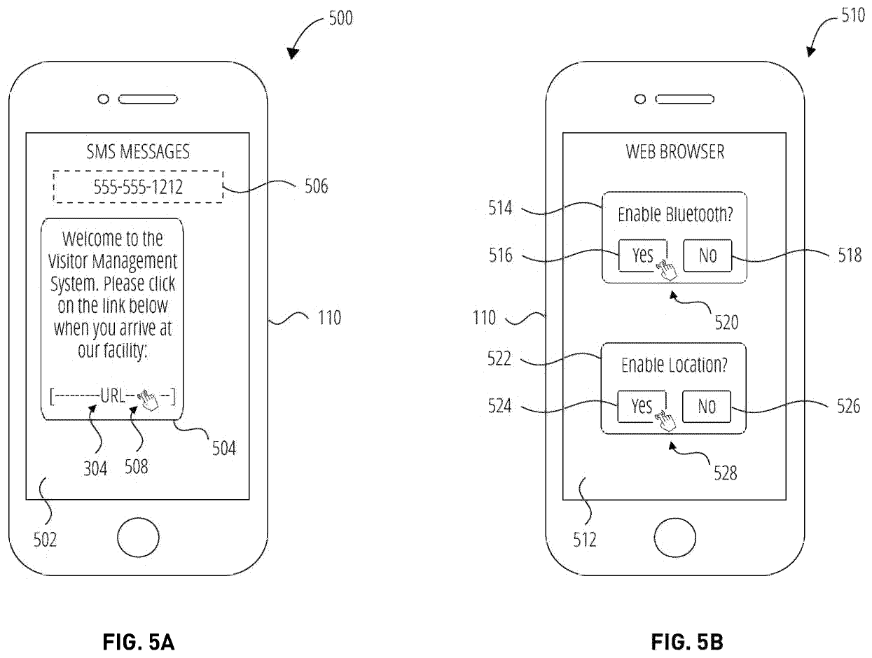

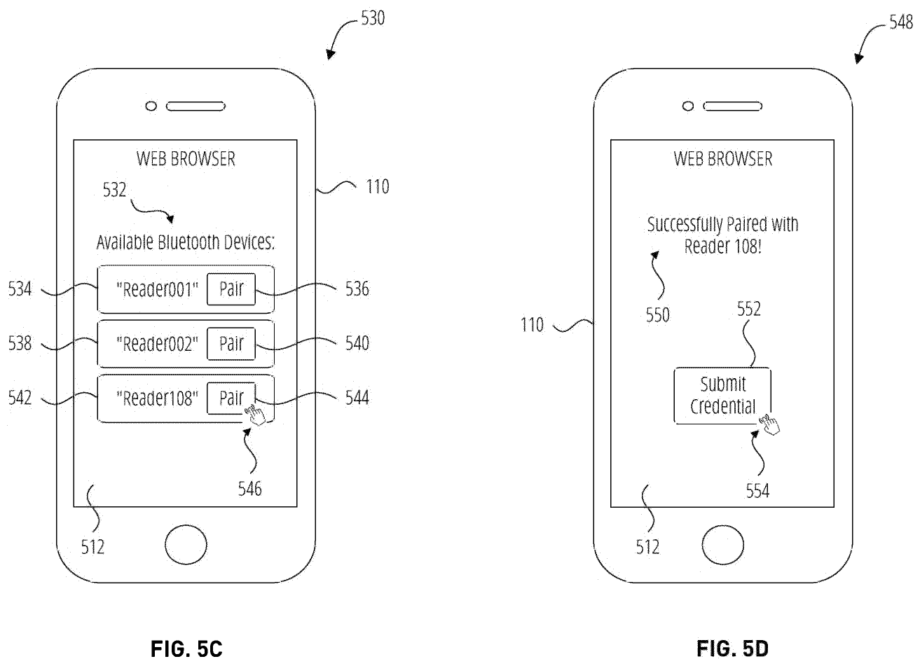

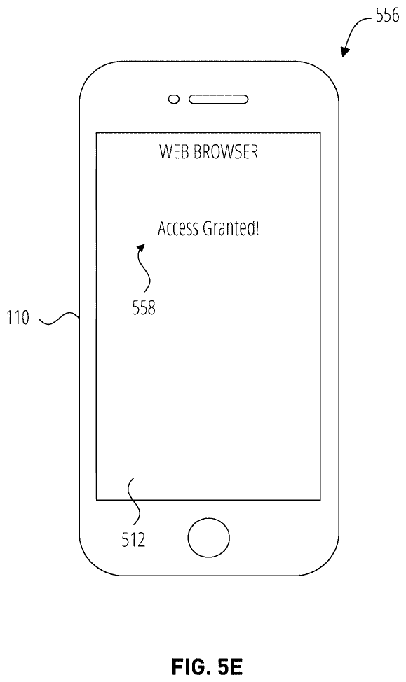

Moreover, it is noted that the method 200 is described herein with reference to the example information-flow diagram 300 of FIG. 3, the example enrollment-portal interface 400 of FIG. 4, and the example mobile-device screenshots 500 of FIGS. 5A, 510 of FIGS. 5B, 530 of FIGS. 5C, 548 of FIG. 5D, and 556 of FIG. 5E. As such, the description below switches among these various figures while stepping through the various operations of the method 200.

At operation 202, the VMS receives an endpoint identifier associated with a visitor. This is represented in the example information-flow diagram 300 of FIG. 3 by the enrollment portal 124 performing a function referred to herein as an enrollment-data receipt 302, by which the enrollment portal 124 receives a mobile number, an email address, or some other endpoint identifier associated with the prospective visitor. An example way in which this could be carried out is depicted using an example enrollment-portal interface 400 in FIG. 4.

As can be seen in FIG. 4, the enrollment-portal interface 400 includes a visitor-information section 402 for receiving information about the upcoming visitor. This visitor information can include one or more endpoint identifiers, and can also include one or more pieces of data (e.g., name) identifying the visitor themselves, and may also include data that indicates when any granted credential would expire. In particular with respect to the embodiment that is depicted in FIG. 4, the visitor-information section 402 includes a first-name field 404, a last-name field 406, and could include one or more other visitor-information fields in various different embodiments.

With respect to one or more endpoint identifiers, the visitor-information section 402 includes a mobile-number field 408 and an email-address field 410. Those two fields can be used respectively for receiving a mobile-phone number associated with the mobile device 110 of the visitor and an email address associated with an email account of the visitor. In some embodiments, only one of these fields is present. In some embodiments in which both fields are present, the enrollment portal 124 accepts submissions that include only one but not the other of those two types of endpoint identifiers. One or more other types of endpoint identifiers could be used in addition to or instead of the two that are depicted in FIG. 4.

The example visitor-information section 402 that is depicted in FIG. 4 also includes fields for receiving expiration information setting forth when any credential granted to the visitor would expire. In at least one embodiment, the VMS invalidates visitor credentials after their respective time period elapses. Specifically with respect to the visitor-information section 402, both an expiration-date field 412 and an expiration-time field 414 are depicted. This is by way of example. In some embodiments, only an expiration-date field is present, and any granted credential would expire on or after that date, depending on the particular implementation. In other embodiments, only an expiration-time field is present, and it is assumed in those embodiments that granted visitor credentials always expire on the day they are granted. And certainly numerous other similar implementations could be utilized.

The last field that is depicted in the example visitor-information section 402 of FIG. 4 is a reader(s) field 416. This field is an example of a more general concept, which is that whomever is “inviting” or registering the visitor may input data that indicates a particular one or more resources to which the visitor is being granted access. In this example, the reader(s) field 416 is a dropdown menu having checkboxes or the like for each of a plurality of readers at the office of the person doing the inviting. According to this example, although not shown, the inviting person checks only one checkbox, and that checkbox corresponds to the reader 108.

Once one, some, or all of the fields have been completed to the satisfaction of the inviting person, that person may click or tap on a submit button 418, shown in the lower right section of the enrollment-portal interface 400. Responsively, at operation 204, the enrollment portal 124 may generate a URL 304 and transmit that URL 304 to the mobile device 110 of the visitor. The enrollment portal 124 may use a text message to send the URL 304 to the mobile device 110. In this example, it is assumed that a mobile number was filled in using the mobile-number field 408. If an email address is provided in addition or instead, the enrollment portal 124 may also or instead transmit the URL 304 to an email account associated with the visitor.

In some embodiments, the enrollment portal 124 constructs the URL 304 such that the URL 304 includes a pseudorandom identifier such as a numerical code or the like. This identifier is referred to herein as being “pseudorandom” only to point out that the identifier may be indecipherable to an observer as conveying any particular information. As one example, the pseudorandom identifier could be a result of a hash function that takes as inputs the visitor's mobile number, a specified expiration time and/or date, a numerical representation of the visitor's last name, and/or the like. In some cases, the identifier may simply be a randomly selected alphanumeric or numeric identifier. In any case, in some embodiments, the enrollment portal 124 may transmit a copy of this identifier and/or the input data to that hash function to the web/BLE server 118 so that the web/BLE server 118 can maintain a data record that may be utilized to generate a corresponding credential upon later receiving a web request from the mobile device 110 of the visitor. And certainly other implementations could be used as well.

At operation 206, the enrollment portal 124 transmits the URL 304 to an endpoint associated with the endpoint identifier that was received at operation 202. As described above, that endpoint and endpoint identifier could be a mobile device and a mobile number, an email account and an email address, and/or the like. In this example, the mobile device 110 of the visitor is used as the example endpoint, and the mobile number (not depicted) of the mobile device 110 is used as the example endpoint identifier. Further to this example, the enrollment portal 124 transmits the URL 304 to the mobile device 110 in a text message (e.g., a Short Messaging Service (SMS) message).

In an example scenario, upon arriving at the abovementioned office building, the visitor opens up an SMS-messaging application 502 on the mobile device 110, as shown in the example mobile-device screenshot 500 of FIG. 5A. As shown in the mobile-device screenshot 500, in addition to displaying the message 504 itself, the SMS-messaging application 502 may also display a source number 506 from which the message 504 was received.

In the example message 504, there is some welcoming text, as well as an instruction to clink on the URL 304 that is provided below that text upon arriving at the host facility (e.g., the office building of the inviting person, the particular floor on which the meeting is to take place, and/or the like). As shown at a tap 508, the visitor in this example has arrived at the office building and has selected the URL 304, as indicated at a URL-selection 306.

The abovementioned URL-selection 306 results in at least one embodiment in a web request 308 being sent from the mobile device 110 to the web/BLE server 118. In at least one embodiment, the domain listed in the URL 304 corresponds to the web/BLE server 118, though some redirecting, proxies, and/or the like could be used in various different implementations.

At operation 208, then, the web/BLE server 118 receives, from the mobile device 110, the web request 308 for a web/BLE webpage corresponding to the URL 304. As shown in FIG. 3, the web/BLE server 118 may responsively engage in some enrollment-validation messaging 310 with the enrollment portal 124 to verify that the web request 308 is valid. Upon successful completion of the enrollment-validation messaging 310, the web/BLE server 118 may then engage in a process referred to herein as a web/BLE-webpage loading 312.

At operation 210, as at least part of the aforementioned web/BLE-webpage loading 312, the web/BLE server 118 generates the requested web/BLE webpage 314. In at least one embodiment, the generated web/BLE webpage 314 contains a valid credential 322 for access to a secured resource, which in this case is the door 102 (or at least what lies beyond it). The credential 322 may be generated by either the enrollment portal 124 or the web/BLE server 118, among other possibilities. The credential 322 may include information about the visitor (e.g., first name and last name), expiration information for the credential 322, and/or one or more other values deemed suitable by those of skill in the art for a given implementation. In some instances, the credential 322 may be-or may be included in-what is often referred to as PACS data.

At operation 212, the web/BLE server 118 transmits the web/BLE webpage 314 to the mobile device 110 of the visitor. Prior to receiving the web/BLE webpage 314 from the web/BLE server 118, the mobile device 110 may have launched a web browser 512 in response to the URL-selection 306 described above. The web browser 512 is depicted in and described in connection with at least FIG. 5B through FIG. 5E. The web browser 512 may be what is known in the art as a “Web BLE Browser,” which is also at times referred to as a browser that implements a “Web Bluetooth API,” and by other names. Some example web browsers that could be used include the “Bluefy BLE Web Browser” from the company PNN Soft in Kyiv, Ukraine, newer versions of Google Chrome for iOS and Android, and/or one or more others known to those of skill in the art.

In at least one embodiment, as is further discussed herein, the web/BLE webpage 314 further contains executable code (e.g., JavaScript) that includes at least one call to at least one function of a web/BLE API. Two examples of what the visitor may see displayed on the mobile device 110 as a result of execution of the JavaScript is shown in the example mobile-device screenshot 510 of FIG. 5B. Those two examples are discussed in the next two paragraphs. (It is noted that other types of executable code could be utilized, and that JavaScript is used in this explanation purely by way of example.) In at least some embodiments, the JavaScript contained in the web/BLE webpage 314 includes instructions for determining whether a Bluetooth function of the mobile device 110 of the visitor is enabled and, if not, displaying a prompt to enable the Bluetooth function of the mobile device of the visitor. That prompt is depicted in FIG. 5B as an enable-bluetooth dialog box 514 having a <Yes> button 516 and a <No> button 518. In the example of FIG. 5B, it can be seen at a tap 520 that the visitor is selecting the <Yes> button 516 to enable the Bluetooth function (i.e., Bluetooth interface) of the mobile device 110.

Similarly, in at least some embodiments, the JavaScript contained in the web/BLE webpage 314 includes instructions for determining whether a location function of the mobile device 110 of the visitor is enabled and, if not, displaying a prompt to enable the location function. That prompt is depicted in FIG. 5B as an enable-location dialog box 522 having a <Yes> button 524 and a <No> button 526. In the example of FIG. 5B, it can be seen at a tap 528 that the visitor is selecting the <Yes> button 524 to enable the location function (e.g., location-based services, GPS, etc.) of the mobile device 110.

As stated above, the web/BLE webpage 314 may include JavaScript code for at least one web BLE API function for triggering at least one operation by a Bluetooth function of the mobile device 110 of the visitor. One or more such Bluetooth operations may be carried out responsive to receiving at least one user-interface command via the web browser 512 when the web browser 512 is displaying the web/BLE webpage 314 on the mobile device 110. The above-described enable-bluetooth dialog box 514 and enable-location dialog box 522 are two examples. Further examples are described below in connection with displaying available Bluetooth devices and transmitting the credential 322 to the reader 108, among other examples.

Among other functions, the web/BLE API that is embedded in the web/BLE webpage 314 handles communication between the web/BLE webpage 314 and the reader 108 via the Bluetooth interface of the mobile device 110. As generalized examples, this communication may include operations such as identifying and connecting to nearby BLE devices, reading and/or writing Bluetooth characteristics, detecting when a Bluetooth device gets disconnected, reading and writing to Bluetooth descriptors, and/or the like. Another function that the web/BLE API may perform is receiving Generic Attribute Profile (GATT) notifications. As known in the art, GATT is the protocol via which two BLE devices transfer data back and forth using concepts called “Services” and “Characteristics.” Continuing now with this description of an example embodiment, operation now continues from the example mobile-device screenshot 510 of FIG. 5B to the example mobile-device screenshot 530 of FIG. 5C. It is also noted that the enable-bluetooth dialog box 514 and the enable-location dialog box 522 may not be displayed at all if both the Bluetooth function and the location function of the mobile device 110 are already enabled at the time. In such a case, operation may proceed from the mobile-device screenshot 500 of FIG. 5A to the example mobile-device screenshot 530 of FIG. 5C.

With respect to further Bluetooth-related functions that are conducted by the web/BLE API that is embedded in the web/BLE webpage 314, it can be seen in the mobile-device screenshot 530 of FIG. 5C that displayed thereon is a Bluetooth-device list 532, which is a list of detected and available Bluetooth (e.g., BLE) devices that are at that time proximate the mobile device 110. The Bluetooth-device list 532 includes (i) a reader-001 entry 534 that corresponds to an arbitrarily named “reader 001” (not pictured) and that has an associated pair button 536, (ii) a reader-002 entry 538 that corresponds to an arbitrarily named (and also not pictured) “reader 002” and that has an associated pair button 540, and (iii) a reader-108 entry 542 that corresponds to the reader 108 and that has an associated pair button 544. As indicated by a tap 546 in FIG. 5C, the visitor in this example selects the reader-108 entry 542 to facilitate communication between the web/BLE webpage 314 and the reader 108.

It is noted that, in some embodiments, the web/BLE webpage 314 instructs the Bluetooth interface of the mobile device 110 to scan for any Bluetooth devices that are advertising a particularly named service. Thus, for example, the reader 108 may advertise a service called something like “Reader_108_Service.” In that case, it may well be that the only entry in the Bluetooth-device list 532 would be the reader-108 entry 542. The reader 108 could advertise a service named just for the visitor to further simplify the user experience. In some cases, an advertised service may be referred to by an identifier such as a universally unique identifier (UUID) for example. Other implementations could be used as well, and may occur to those of skill in the art having the benefit of the present disclosure.

Following the selection by the visitor of the pair button 544 that is associated with the reader-108 entry 542 and therefore with the reader 108, the web browser 512 may next display a screen such as the example mobile-device screenshot 548 of FIG. 5D. On that screenshot, it can be seen that displayed thereon are a status message 550 and a submit-credential button 552. The status message 550 in this example indicates that the pairing with the reader 108 was successful. In some embodiments, the pairing involves exchange of a challenge 318 and a response 320 between the web/BLE webpage 314 and the reader 108, as depicted by way of example in FIG. 3. Furthermore, subsequent to the pairing, it can be seen at a tap 554 that the visitor is actuating the submit-credential button 552, which, in at least one embodiment, causes the web/BLE webpage 314 to submit the credential 322 (and perhaps additional PACS data) to the reader 108 using BLE communication.

The above described screens and actions taken in connection with FIG. 5C and FIG. 5D correspond with an access-request receipt 316 that is depicted in FIG. 3. The access-request receipt 316 involves or includes receiving, via the user interface presented by the web browser 512 on the mobile device 110, a request from the visitor to access the secured resource that is protected by the reader 108 and the associated locking mechanism on the door 102. In some embodiments, the aspects shown in and described in connection with the mobile-device screenshot 530 of FIG. 5C are automated, and occur “behind the scenes” from the perspective of the visitor. In an example, the pairing with the reader 108 could be performed automatically based on proximity to (inferred from, e.g., a signal strength of) the reader 108. The submission to the reader 108 of the credential 322 could also be done programmatically in response to proximity, location, and/or one or more other triggering conditions.

At operation 214, the reader 108 receives the credential 322 from the mobile device 110 via a BLE communication that is directed by the web/BLE webpage 314 using the embedded web/BLE API. The reader 108 may then respond to the web/BLE webpage 314 with a communication status 324, as shown in FIG. 3. As described above, the reader 108 may then exchange verification messaging with a device such as the access server 114 in order to verify the credential 322. In some embodiments, the credential 322 is encrypted using one or more encryption keys.

At operation 216, the VMS verifies the credential and accordingly grants access to the secured resource, which in this case is entry through the door 102. This is represented on FIG. 3 as an access grant 326. As show in the mobile-device screenshot 556 of FIG. 5E, a status message 558 may be presented by the web browser 512. The example status message 558 that is shown in FIG. 5E says, “Access Granted!”

Moreover, the reader 108 may have stored therein a copy of a master key, which may be particular to the door 102 (i.e., to the reader 108), or which may be more broadly associated with multiple readers. The reader 108 may keep its copy of the master key stored in what is known in the art as a secure element, which the reader 108 may use for storage of confidential data, for conducting certain cryptographic methods (e.g., operations), and/or the like. In an example embodiment, the credential 322 may be or include a diversified key that had been derived from the abovementioned master key that is stored in the reader 108. This master key may also be stored in another entity of the associated encryption system, such as a hardware security module for example.

The web/BLE webpage 314 may transmit this diversified key to the reader 108 along with what is known as a diversification value (or “diversifier”). The reader 108 may then dynamically use its copy of the master key and the diversification value received from the web/BLE webpage 314 to compute a diversified key of its own (using a suitable key derivation function (KDF) as known to those of skill in the art), which the reader 108 may then compare with the diversified key that the reader 108 received from the web/BLE webpage 314. In the case of a match, access may be granted. If there is not a match, the reader 108 may simply do nothing, may issue a follow-up message to the web/BLE webpage 314 to give the web/BLE webpage 314 another chance, or some other response (or lack of response) deemed suitable by those of skill in the art for a given implementation. In some scenarios, the reader 108 may keep a stored table of diversification values associated with corresponding diversified keys, though this may be considered less secure than the above-described “on-the-fly” calculation of the diversified key by the reader 108.

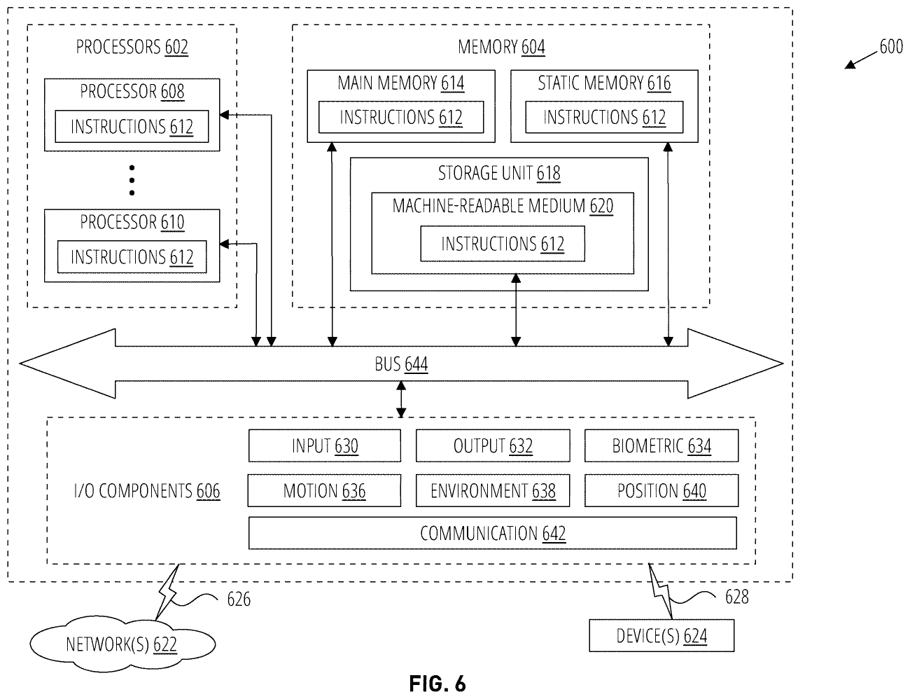

FIG. 6 depicts an example computer system 600 that could be utilized to embody and/or perform at least one embodiment, and within which instructions 612 (e.g., software, a program, an application, an applet, an app, and/or other executable code) may be executed to cause the computer system 600 to perform any one or more of the methodologies discussed herein. For example, execution of the instructions 612 may cause the computer system 600 to perform any one or more of the methods described herein. The instructions 612 transform the general, non-programmed computer system 600 into a particular computer system 600 programmed to carry out the described and illustrated functions in the manner described. The computer system 600 may operate as a standalone device or may be coupled (e.g., networked) to other machines. In a networked deployment, the computer system 600 may operate in the capacity of a server machine or a client machine in a server-client network environment, or as a peer machine in a peer-to-peer (or distributed) network environment.

The computer system 600 may be or include, but is limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, and/or any other machine capable of executing the instructions 612, sequentially or otherwise, that specify actions to be taken by the computer system 600. Further, while only a single computer system 600 is illustrated, the term “machine” shall also be taken to include a collection of machines that individually or jointly execute the instructions 612 to perform any one or more of the methodologies discussed herein.

The computer system 600 may include processors 602, memory 604, and I/O components 606, which may be configured to communicate with each other via a bus 644. In an example embodiment, the processors 602 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, and/or any suitable combination thereof) may include, for example, a processor 608 and a processor 610 that execute the instructions 612. The term “processor” is intended to include multi-core processors that may include two or more independent processors (sometimes referred to as “cores”) that may execute instructions contemporaneously.

Although FIG. 6 shows multiple processors 602, the computer system 600 may include a single processor with a single core, a single processor with multiple cores (e.g., a multi-core processor), multiple processors with a single core, multiple processors with multiples cores, or any combination thereof.

The memory 604 includes a main memory 614, a static memory 616, and a storage unit 618, each of which is accessible to the processors 602 via the bus 644. The memory 604, the static memory 616, and/or the storage unit 618 may store the instructions 612 executable for performing any one or more of the methodologies or functions described herein. The instructions 612 may also or instead reside completely or partially within the main memory 614, within the static memory 616, within machine-readable medium 620 within the storage unit 618, within at least one of the processors 602 (e.g., within a cache memory of a given one of the processors 602), and/or any suitable combination thereof, during execution thereof by the computer system 600. The machine-readable medium 620 is one or more non-transitory computer-readable storage media.

The I/O components 606 may include a wide variety of components to receive input, produce and/or provide output, transmit information, exchange information, capture measurements, and/or the like. The specific I/O components 606 that are included in a particular instance of the computer system 600 will depend on the type of machine. For example, portable machines such as mobile phones may include a touch input device or other such input mechanisms, while a headless server machine may not include such a touch input device. It will be appreciated that the I/O components 606 may include many other components that are not shown in FIG. 6.

In various example embodiments, the I/O components 606 may include output components 632 and input components 630. The output components 632 may include visual components (e.g., a display such as a plasma display panel (PDP), a light emitting diode (LED) display, a liquid crystal display (LCD), a projector, and/or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touchscreen configured to receive alphanumeric input, a photo-optical keyboard, and/or other alphanumeric input components), point-based input components (e.g., a mouse, a touchpad, a trackball, a joystick, a motion sensor, and/or one or more other pointing instruments), tactile input components (e.g., a physical button, a touchscreen that is responsive to location and/or force of touches or touch gestures, and/or one or more other tactile input components), audio input components (e.g., a microphone), and/or the like.

In further example embodiments, the I/O components 606 may include biometric components 634, motion components 636, environmental components 638, and/or position components 640, among a wide array of other components. The biometric components 634 may include components to detect expressions (e.g., hand expressions, facial expressions, vocal expressions, body gestures, eye tracking, and/or the like), measure biosignals (e.g., blood pressure, heart rate, body temperature, perspiration, brain waves, and/or the like), identify a person (by way of, e.g., voice identification, retinal identification, facial identification, fingerprint identification, and/or electroencephalogram-based identification), and/or the like. The motion components 636 may include acceleration-sensing components (e.g., an accelerometer), gravitation-sensing components, rotation-sensing components (e.g., a gyroscope), etc.

The environmental components 638 may include, for example, illumination-sensing components (e.g., a photometer), temperature-sensing components (e.g., one or more thermometers), humidity-sensing components, pressure-sensing components (e.g., a barometer), acoustic-sensing components (e.g., one or more microphones), proximity-sensing components (e.g., infrared sensors that detect nearby objects), gas-sensing components (e.g., gas-detection sensors to detection concentrations of hazardous gases for safety and/or to measure pollutants in the atmosphere), and/or other components that may provide indications, measurements, signals, and/or the like that correspond to a surrounding physical environment. The position components 640 may include location-sensing components (e.g., a global positioning system (GPS) receiver), altitude-sensing components (e.g., altimeters and/or barometers that detect air pressure from which altitude may be derived), orientation-sensing components (e.g., magnetometers), and/or the like.

Communication may be implemented using a wide variety of technologies. The I/O components 606 may further include communication components 642 operable to communicatively couple the computer system 600 to a network 622 and/or devices 624 via a coupling 626 and/or a coupling 628, respectively. For example, the communication components 642 may include a network-interface component or another suitable device to interface with the network 622. In further examples, the communication components 642 may include wired-communication components, wireless-communication components, cellular-communication components, Near Field Communication (NFC) components, Bluetooth (e.g., Bluetooth Low Energy) components, Wi-Fi components, and/or other communication components to provide communication via one or more other modalities. The devices 624 may include one or more other machines and/or any of a wide variety of peripheral devices (e.g., a peripheral device coupled via a universal serial bus (USB) connection).

Moreover, the communication components 642 may detect identifiers or include components operable to detect identifiers. For example, the communication components 642 may include radio frequency identification (RFID) tag reader components, NFC-smart-tag detection components, optical-reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and/or other optical codes), and/or acoustic-detection components (e.g., microphones to identify tagged audio signals). In addition, a variety of information may be derived via the communication components 642, such as location via Internet Protocol (IP) geolocation, location via Wi-Fi signal triangulation, location via detecting an NFC beacon signal that may indicate a particular location, and/or the like.

One or more of the various memories (e.g., the memory 604, the main memory 614, the static memory 616, and/or the (e.g., cache) memory of one or more of the processors 602) and/or the storage unit 618 may store one or more sets of instructions (e.g., software) and/or data structures embodying or used by any one or more of the methodologies or functions described herein. These instructions (e.g., the instructions 612), when executed by one or more of the processors 602, cause various operations to implement various embodiments of the present disclosure.

The instructions 612 may be transmitted or received over the network 622, using a transmission medium, via a network-interface device (e.g., a network-interface component included in the communication components 642) and using any one of a number of well-known transfer protocols (e.g., the Session Initiation Protocol (SIP), the hypertext transfer protocol (HTTP), and/or the like). Similarly, the instructions 612 may be transmitted or received using a transmission medium via the coupling 628 (e.g., a peer-to-peer coupling) to the devices 624.

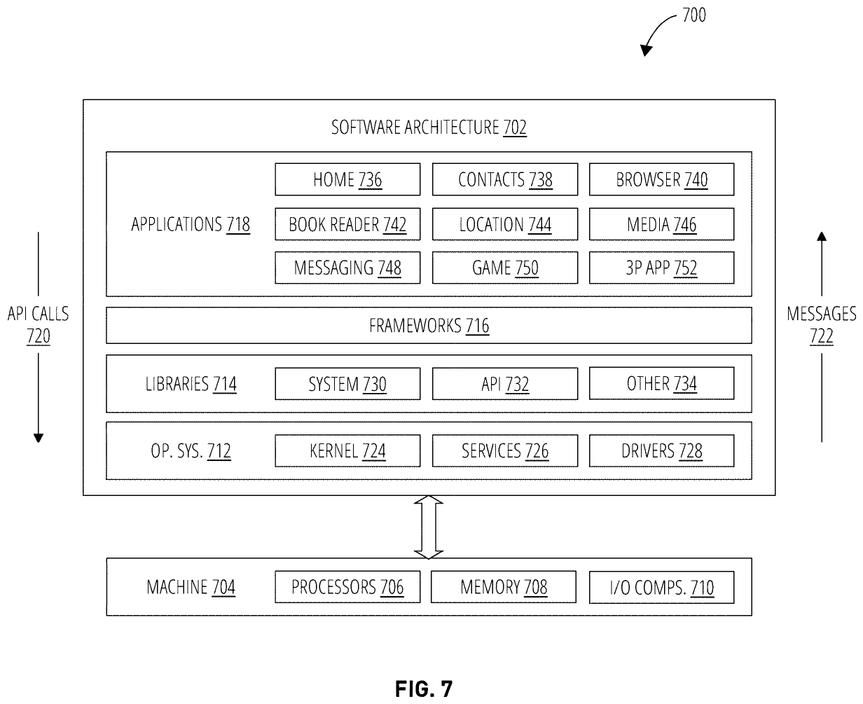

FIG. 7 depicts an example software architecture 702 that could be executed on the example computer system 600 of FIG. 6, in accordance with at least one embodiment. The illustrated example software architecture 702 can be installed on any one or more of the devices described herein. For example, the software architecture 702 could be installed on any device or system that is arranged similar to the computer system 600 of FIG. 6. The software architecture 702 is supported by hardware such as a machine 704 that includes processors 706, memory 708, and I/O components 710. In this example, the software architecture 702 can be conceptualized as a stack of layers, where each layer provides a particular functionality. The software architecture 702 includes layers such an operating system 712, libraries 714, frameworks 716, and applications 718. Operationally, using one or more application programming interfaces (APIs), the applications 718 invoke API calls 720 through the software stack and receive messages 722 in response to the API calls 720.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 may provide memory management, processor management (e.g., scheduling), component management, networking, and/or security settings, in some cases among other functionality. The services 726 can provide other common services for the other software layers. The drivers 728 are responsible for controlling or interfacing with the underlying hardware. For instance, the drivers 728 can include display drivers, camera drivers, Bluetooth or Bluetooth Low Energy drivers, flash memory drivers, serial communication drivers (e.g., USB drivers), Wi-Fi drivers, audio drivers, power management drivers, and/or the like.

The libraries 714 provide a low-level common infrastructure used by the applications 718. The libraries 714 can include system libraries 730 (e.g., a C standard library) that provide functions such as memory-allocation functions, string-manipulation functions, mathematic functions, and/or the like. In addition, the libraries 714 can include API libraries 732 such as media libraries (e.g., libraries to support presentation and/or manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG), and/or the like), graphics libraries (e.g., an OpenGL framework used to render in two dimensions (2D) and three dimensions (3D) in graphic content on a display), database libraries (e.g., SQLite to provide various relational-database functions), web libraries (e.g., WebKit to provide web-browsing functionality), and/or the like. The libraries 714 can also include a wide variety of other libraries 734 to provide many other APIs to the applications 718.

The frameworks 716 may provide a high-level common infrastructure that is used by the applications 718. For example, the frameworks 716 may provide various graphical user interface (GUI) functions, high-level resource management, high-level location services, and/or the like. The frameworks 716 can provide a broad spectrum of other APIs that can be used by the applications 718, some of which may be specific to a particular operating system or platform.

Purely as representative examples, the applications 718 may include a home application 736, a contacts application 738, a browser application 740, a book-reader application 742, a location application 744, a media application 746, a messaging application 748, a game application 750, and/or a broad assortment of other applications generically represented in FIG. 7 as a third-party application 752. The applications 718 are programs that execute functions defined in the programs. Various programming languages can be employed to create one or more of the applications 718, structured in a variety of manners, such as object-oriented programming languages (e.g., Objective-C, Java, C++, etc.), procedural programming languages (e.g., C, assembly language, etc.), and/or the like. In a specific example, the third-party application 752 (e.g., an application developed using the ANDROID™ or IOS™ software development kit (SDK) by an entity other than the vendor of the particular platform) could be mobile software running on a mobile operating system such as IOSTM, ANDROID™, WINDOWS® Phone, and/or the like. In this example, the third-party application 752 can invoke the API calls 720 provided by the operating system 712 to facilitate functionality described herein.

In view of the disclosure above, a listing of various examples of embodiments is set forth below. It should be noted that one or more features of an example, taken in isolation or combination, should be considered to be within the disclosure of this application.

Example 1 is a method performed by a computing system executing instructions on at least one hardware processor. The method includes receiving an endpoint identifier associated with a visitor; generating a URL associated with the endpoint identifier; transmitting the URL to an endpoint associated with the endpoint identifier; receiving, from a mobile device associated with the visitor, a request for a web/BLE webpage corresponding to the URL; generating the requested web/BLE webpage, the web/BLE webpage containing a valid credential for access to a secured resource, the web/BLE webpage further containing executable code that includes at least one call to at least one function of a web/BLE API; transmitting the web/BLE webpage to the mobile device of the visitor; receiving the credential from the mobile device of the visitor via a BLE communication; and verifying the credential and accordingly granting access to the secured resource.

Example 2 is the method of Example 1, where generating the URL associated with the endpoint identifier includes including, in the URL, a pseudorandom identifier uniquely associated at the computing system with the endpoint identifier associated with the user.

Example 3 is the method of Example 1 or Example 2, where the endpoint identifier includes a mobile-phone number associated with the mobile device of the visitor; and transmitting the URL to the endpoint associated with the endpoint identifier includes transmitting the URL to the mobile device of the visitor.

Example 4 is the method of Example 3, where transmitting the URL to the mobile device of the visitor includes transmitting the URL to the mobile device of the visitor in a text message.

Example 5 is the method of any of the Examples 1-4, where the endpoint identifier includes an email address associated with an email account of the visitor; and transmitting the URL to the endpoint associated with the endpoint identifier includes transmitting, in an email message, the URL to the email account of the visitor.

Example 6 is the method of any of the Examples 1-5, where the web/BLE webpage further contains executable code for determining whether a Bluetooth function of the mobile device of the visitor is enabled and, if not, displaying a prompt to enable the Bluetooth function of the mobile device of the visitor.

Example 7 is the method of any of the Examples 1-6, where the web/BLE webpage further contains executable code for determining whether a location function of the mobile device of the visitor is enabled and, if not, displaying a prompt to enable the location function of the mobile device of the visitor.

Example 8 is the method of any of the Examples 1-7, where the at least one function of the web/BLE API includes instructions for triggering at least one operation by a Bluetooth function of the mobile device of the visitor responsive to receiving at least one user-interface command via a web browser displaying the web/BLE webpage on the mobile device.

Example 9 is the method of any of the Examples 1-8, further including receiving information about the visitor, where the credential includes the received information about the visitor.

Example 10 is the method of any of the Examples 1-9, further including receiving expiration information setting forth when the credential expires; and invalidating the credential after a time period that is based on the expiration information.

Example 11 is a computing system that includes at least one hardware processor; one or more non-transitory computer readable storage media containing instructions that, when executed by the at least one hardware processor, cause the computing system to perform operations including: receiving an endpoint identifier associated with a visitor; generating a URL associated with the endpoint identifier; transmitting the URL to an endpoint associated with the endpoint identifier; receiving, from a mobile device associated with the visitor, a request for a web/BLE webpage corresponding to the URL, generating the requested web/BLE webpage, the web/BLE webpage containing a valid credential for access to a secured resource, the web/BLE webpage further containing executable code that includes at least one call to at least one function of a web/BLE API; transmitting the web/BLE webpage to the mobile device of the visitor; receiving the credential from the mobile device of the visitor via a BLE communication; and verifying the credential and accordingly granting access to the secured resource.

Example 12 is the computing system of Example 11, where generating the URL associated with the endpoint identifier includes including, in the URL, a pseudorandom identifier uniquely associated at the computing system with the endpoint identifier associated with the user.

Example 13 is the computing system of Example 11 or Example 12, where the endpoint identifier includes a mobile-phone number associated with the mobile device of the visitor; and transmitting the URL to the endpoint associated with the endpoint identifier includes transmitting the URL to the mobile device of the visitor.

Example 14 is the computing system of Example 13, where transmitting the URL to the mobile device of the visitor includes transmitting the URL to the mobile device of the visitor in a text message.

Example 15 is the computing system of any of the Examples 11-14, where the endpoint identifier includes an email address associated with an email account of the visitor; and transmitting the URL to the endpoint associated with the endpoint identifier includes transmitting, in an email message, the URL to the email account of the visitor.

Example 16 is the computing system of any of the Examples 11-15, where the web/BLE webpage further contains executable code for determining whether a Bluetooth function of the mobile device of the visitor is enabled and, if not, displaying a prompt to enable the Bluetooth function of the mobile device of the visitor.

Example 17 is the computing system of any of the Examples 11-16, where the web/BLE webpage further contains executable code for determining whether a location function of the mobile device of the visitor is enabled and, if not, displaying a prompt to enable the location function of the mobile device of the visitor.

Example 18 is the computing system of any of the Examples 11-17, where the at least one function of the web/BLE API includes instructions for triggering at least one operation by a Bluetooth function of the mobile device of the visitor responsive to receiving at least one user-interface command via a web browser displaying the web/BLE webpage on the mobile device.

Example 19 is the computing system of any of the Examples 11-18, the operations further including receiving information about the visitor, where the credential includes the received information about the visitor.

Example 20 is the computing system of any of the Examples 11-19, the operations further including receiving expiration information setting forth when the credential expires; and invalidating the credential after a time period that is based on the expiration information.

Example 21 is one or more non-transitory computer readable storage media containing instructions that, when executed by the at least one hardware processor, cause the computing system to perform operations including receiving an endpoint identifier associated with a visitor; generating a URL associated with the endpoint identifier; transmitting the URL to an endpoint associated with the endpoint identifier; receiving, from a mobile device associated with the visitor, a request for a web/BLE webpage corresponding to the URL; generating the requested web/BLE webpage, the web/BLE webpage containing a valid credential for access to a secured resource, the web/BLE webpage further containing executable code that includes at least one call to at least one function of a web/BLE API; transmitting the web/BLE webpage to the mobile device of the visitor; receiving the credential from the mobile device of the visitor via a BLE communication; and verifying the credential and accordingly granting access to the secured resource.

Example 22 is the one or more non-transitory computer readable storage media of Example 21, where generating the URL associated with the endpoint identifier includes including, in the URL, a pseudorandom identifier uniquely associated at the computing system with the endpoint identifier associated with the user.

Example 23 is the one or more non-transitory computer readable storage media of Example 21 or Example 22, where the endpoint identifier includes a mobile-phone number associated with the mobile device of the visitor; and transmitting the URL to the endpoint associated with the endpoint identifier includes transmitting the URL to the mobile device of the visitor.

Example 24 is the one or more non-transitory computer readable storage media of Example 23, where transmitting the URL to the mobile device of the visitor includes transmitting the URL to the mobile device of the visitor in a text message.

Example 25 is the one or more non-transitory computer readable storage media of any of the Examples 21-24, where the endpoint identifier includes an email address associated with an email account of the visitor; and transmitting the URL to the endpoint associated with the endpoint identifier includes transmitting, in an email message, the URL to the email account of the visitor.

Example 26 is the one or more non-transitory computer readable storage media of any of the Examples 21-25, where the web/BLE webpage further contains executable code for determining whether a Bluetooth function of the mobile device of the visitor is enabled and, if not, displaying a prompt to enable the Bluetooth function of the mobile device of the visitor.

Example 27 is the one or more non-transitory computer readable storage media of any of the Examples 21-26, where the web/BLE webpage further contains executable code for determining whether a location function of the mobile device of the visitor is enabled and, if not, displaying a prompt to enable the location function of the mobile device of the visitor.

Example 28 is the one or more non-transitory computer readable storage media of any of the Examples 21-27, where the at least one function of the web/BLE API includes instructions for triggering at least one operation by a Bluetooth function of the mobile device of the visitor responsive to receiving at least one user-interface command via a web browser displaying the web/BLE webpage on the mobile device.

Example 29 is the one or more non-transitory computer readable storage media of any of the Examples 21-28, the operations further including receiving information about the visitor, where the credential includes the received information about the visitor.

Example 30 is the one or more non-transitory computer readable storage media of any of the Examples 21-29, the operations further including receiving expiration information setting forth when the credential expires; and invalidating the credential after a time period that is based on the expiration information.

Furthermore, in this disclosure, in one or more embodiments, examples, and/or the like, it may be the case that one or more components of one or more devices, systems, and/or the like are referred to as modules that carry out (e.g., perform, execute, and the like) various functions. With respect to any such usages in the present disclosure, a module includes both hardware and instructions. The hardware could include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more devices and/or components of any other type deemed suitable by those of skill in the art for a given implementation.

In at least one embodiment, the instructions for a given module are executable by the hardware for carrying out the one or more herein-described functions of the module, and could include hardware (e.g., hardwired) instructions, firmware instructions, software instructions, and/or the like, stored in any one or more non-transitory computer-readable storage media deemed suitable by those of skill in the art for a given implementation. Each such non-transitory computer-readable storage medium could be or include memory (e.g., random access memory (RAM), read-only memory (ROM), erasable programmable read-only memory (EPROM), electrically erasable programmable read-only memory (EEPROM a.k.a. E2PROM), flash memory, and/or one or more other types of memory) and/or one or more other types of non-transitory computer-readable storage medium. A module could be realized as a single component or be distributed across multiple components. In some cases, a module may be referred to as a unit.

Moreover, consistent with the fact that the entities and arrangements that are described herein, including the entities and arrangements that are depicted in and described in connection with the drawings, are presented as examples and not by way of limitation, any and all statements or other indications as to what a particular drawing “depicts,” what a particular element or entity in a particular drawing or otherwise mentioned in this disclosure “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively qualified by such a clause. It is for reasons akin to brevity and clarity of presentation that this implied qualifying clause is not repeated ad nauseum in this disclosure.

1. A method performed by a computing system executing instructions on at least one hardware processor, the method comprising:
receiving an endpoint identifier associated with a visitor;
generating a uniform resource locator (URL) associated with the endpoint identifier;
transmitting the URL to an endpoint associated with the endpoint identifier;
receiving, from a mobile device associated with the visitor, a request for a web/Bluetooth Low Energy (BLE) webpage corresponding to the URL;
generating the requested web/BLE webpage, the web/BLE webpage containing a valid credential for access to a secured resource, the web/BLE webpage further containing executable code that includes at least one call to at least one function of a web/BLE application programming interface (API);
transmitting the web/BLE webpage to the mobile device of the visitor;
receiving the credential from the mobile device of the visitor via a BLE communication; and
verifying the credential and accordingly granting access to the secured resource.

2. The method of claim 1, wherein generating the URL associated with the endpoint identifier comprises including, in the URL, a pseudorandom identifier uniquely associated at the computing system with the endpoint identifier associated with the user.

3. The method of claim 1, wherein:
the endpoint identifier comprises a mobile-phone number associated with the mobile device of the visitor; and
transmitting the URL to the endpoint associated with the endpoint identifier comprises transmitting the URL to the mobile device of the visitor.

4. The method of claim 3, wherein transmitting the URL to the mobile device of the visitor comprises transmitting the URL to the mobile device of the visitor in a text message.

5. The method of claim 1, wherein:
the endpoint identifier comprises an email address associated with an email account of the visitor; and
transmitting the URL to the endpoint associated with the endpoint identifier comprises transmitting, in an email message, the URL to the email account of the visitor.

6. The method of claim 1, wherein the web/BLE webpage further contains executable code for determining whether a Bluetooth function of the mobile device of the visitor is enabled and, if not, displaying a prompt to enable the Bluetooth function of the mobile device of the visitor.

7. The method of claim 1, wherein the web/BLE webpage further contains executable code for determining whether a location function of the mobile device of the visitor is enabled and, if not, displaying a prompt to enable the location function of the mobile device of the visitor.

8. The method of claim 1, wherein the at least one function of the web/BLE API comprises instructions for triggering at least one operation by a Bluetooth function of the mobile device of the visitor responsive to receiving at least one user-interface command via a web browser displaying the web/BLE webpage on the mobile device.

9. The method of claim 1, further comprising receiving information about the visitor, wherein the credential comprises the received information about the visitor.

10. The method of claim 1, further comprising:
receiving expiration information setting forth when the credential expires; and
invalidating the credential after a time period that is based on the expiration information.

11. A computing system comprising:
at least one hardware processor; and
one or more non-transitory computer readable storage media containing instructions that, when executed by the at least one hardware processor, cause the computing system to perform operations comprising:
receiving an endpoint identifier associated with a visitor;
generating a uniform resource locator (URL) associated with the endpoint identifier;
transmitting the URL to an endpoint associated with the endpoint identifier;
receiving, from a mobile device associated with the visitor, a request for a web/Bluetooth Low Energy (BLE) webpage corresponding to the URL;
generating the requested web/BLE webpage, the web/BLE webpage containing a valid credential for access to a secured resource, the web/BLE webpage further containing executable code that includes at least one call to at least one function of a web/BLE application programming interface (API);
transmitting the web/BLE webpage to the mobile device of the visitor;
receiving the credential from the mobile device of the visitor via a BLE communication; and
verifying the credential and accordingly granting access to the secured resource.

12. The computing system of claim 11, wherein generating the URL associated with the endpoint identifier comprises including, in the URL, a pseudorandom identifier uniquely associated at the computing system with the endpoint identifier associated with the user.

13. The computing system of claim 11, wherein:
the endpoint identifier comprises a mobile-phone number associated with the mobile device of the visitor; and
transmitting the URL to the endpoint associated with the endpoint identifier comprises transmitting the URL to the mobile device of the visitor.

14. The computing system of claim 13, wherein transmitting the URL to the mobile device of the visitor comprises transmitting the URL to the mobile device of the visitor in a text message.

15. The computing system of claim 11, wherein:
the endpoint identifier comprises an email address associated with an email account of the visitor; and
transmitting the URL to the endpoint associated with the endpoint identifier comprises transmitting, in an email message, the URL to the email account of the visitor.

16. The computing system of claim 11, wherein the web/BLE webpage further contains executable code for determining whether a Bluetooth function of the mobile device of the visitor is enabled and, if not, displaying a prompt to enable the Bluetooth function of the mobile device of the visitor.

17. The computing system of claim 11, wherein the web/BLE webpage further contains executable code for determining whether a location function of the mobile device of the visitor is enabled and, if not, displaying a prompt to enable the location function of the mobile device of the visitor.

18. The computing system of claim 11, wherein the at least one function of the web/BLE API comprises instructions for triggering at least one operation by a Bluetooth function of the mobile device of the visitor responsive to receiving at least one user-interface command via a web browser displaying the web/BLE webpage on the mobile device.

19. The computing system of claim 11, the operations further comprising receiving information about the visitor, wherein the credential comprises the received information about the visitor.

20. The computing system of claim 11, the operations further comprising:
receiving expiration information setting forth when the credential expires; and
invalidating the credential after a time period that is based on the expiration information.

21-30. (canceled)
